(19) United States
(12) Patent Application Publication
(10) Pub. No.: US 2009/0172232 A1
(43) Pub. Date: Jul. 2, 2009

(54) METHOD AND SYSTEM FOR HANDLING A MANAGEMENT INTERRUPT EVENT

(76) Inventors: Vincent J. Zimmer, Federal Way, WA (US); Michael A. Rothman, Puyallup, WA (US)

Correspondence Address: Barnes & Thornburg, LLP, c/o CPA Global, P.O. Box 52050, Minneapolis, MN, 55402, US

(21) Appl. No.: 11/966,150

(22) Filed: Dec. 28, 2007

(51) Int. Cl. G06F 13/24

(52) U.S. Cl. 710/268

(57) ABSTRACT

A method and system for handling a management interrupt, such as a system management interrupt (SMI) and/or a platform management interrupt (PMI), includes sequestering one or more processor cores for handling the management interrupt. Generated management interrupts are directed to the sequestered processor core and not to other processor cores allocated to a main partition. The sequestered processor core(s) handles the management interrupt without disrupting the current operation of the remaining processor cores.

### BACKGROUND

System management mode (SMM) is a special-purpose operating mode used by some processors to handle system-wide functions such as, for example, power management, system hardware control, or proprietary OEM (Original Equipment Manufacturer) designed code. System management mode is typically hidden from any operating system being executed by the processor. The processor, or individual cores of the processor, may be directed into system management mode by generation of a management interrupt event such as system management interrupt (SMI) or a platform management interrupt (PMI) depending upon the particular processor architecture. Such management interrupt events generally take precedence over non-maskable and maskable interrupts. In a typical multi-core processor, the platform management interrupt is directed to each processor core in response to a platform event (e.g., an error condition or chipset timer) to asynchronously transition all processor cores to a system management mode. Each processor core may independently handle the system management interrupt or platform management interrupt in a system management mode.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of a computing device having a sequestered processor core; and

FIG. 2 is a simplified flowchart of an algorithm for sequestering a processor core for handling system and/or platform management interrupts.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

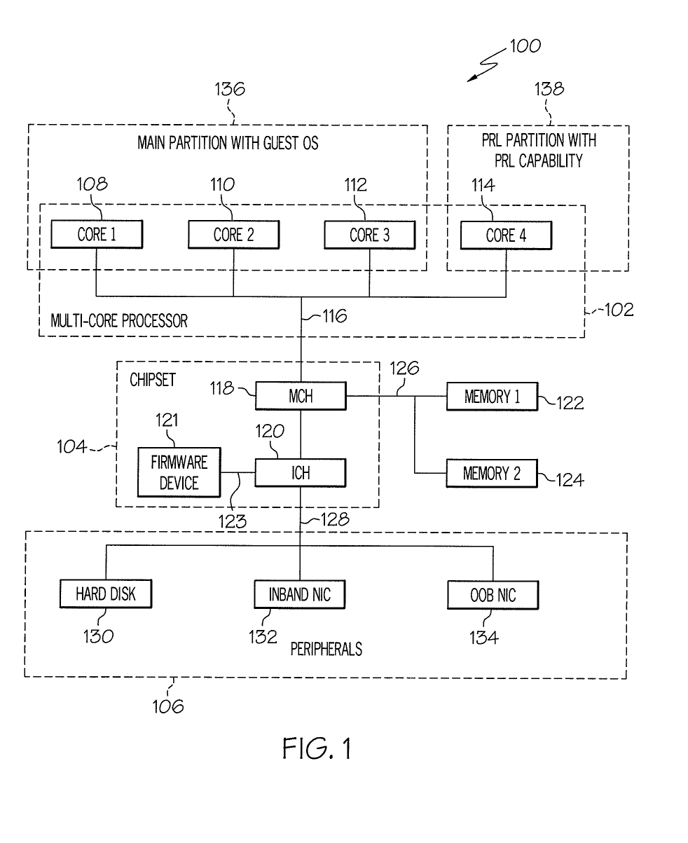

Referring now to FIG. 1, in one embodiment, a computing device 100 includes a multi-core processor 102, a chipset 104, and a number of peripheral devices 106. The computing device 100 may be embodied as any type of computing device such as, for example, a desktop computer system, a laptop computer system, a server or enterprise computer system, or a handheld computing device. The multi-core processor 102 illustratively includes four processor cores 108, 110, 112, 114. However, in other embodiments, the processor 102 may include two, three, or more processor cores. For example, in one particular embodiment, the processor 102 includes 128 processor cores.

The processor 102 is communicatively coupled to the chipset 104 via a number of signal paths 116. The signal paths 116 may be embodied as any type of signal paths capable of facilitating communication between the processor 102 and the chipset 104. For example, the signal paths 116 may be embodied as any number of wires, printed circuit board traces, via, bus, point-to-point interconnects, intervening devices, and/or the like. The chipset 104 includes a memory controller hub (MCH) or northbridge 118, an input/output controller hub (ICH) or southbridge 120, and a firmware device 121. The firmware device 121 is communicatively coupled to the input/output controller hub 120 via a number of signal paths 123. Similar to the signal paths 116, the signal paths 123 may be embodied as any type of signal paths capable of facilitating communication between the input/output controller hub 120 and the firmware device 121 such as, for example, any number of wires, printed circuit board traces, via, bus, point-to-point interconnects, intervening devices, and/or the like. The firmware device 121 is illustratively embodied as a memory storage device for storing Basic Input/Output System (BIOS) data and/or instructions and/or other information.

The memory controller hub 118 is communicatively coupled to a number of memory devices 122, 124 via a number of signal paths 126. Again, similar to the signal paths 116, the signal paths 126 may be embodied as any type of signal paths capable of facilitating communication between the memory controller hub 118 and the memory devices 122, 124 such as, for example, any number of wires, printed circuit board traces, via, bus, point-to-point interconnects, intervening devices, and/or the like. The memory devices 122, 124 may be embodied as dynamic random access memory devices (DRAM), synchronous dynamic random access memory devices (SDRAM), double-data rate dynamic random access memory device (DDR SDRAM), and/or other volatile memory devices. Additionally, although only two memory devices are illustrated in FIG. 1, in other embodiments, the computing device 100 may include addition memory devices.

The chipset 104 is also communicatively coupled to a number of peripherals 106 via signal paths 128. Again, similar to the signal paths 116, 126, the signal paths 128 may be embodied as any type of signal paths capable of facilitating communication between the chipset 104 and the peripherals 106 such as, for example, any number of wires, printed circuit board traces, via, bus, point-to-point interconnects, intervening devices, and/or the like. The peripherals 106 may include any number of peripheral devices including data storage devices, interfaces, and output devices. For example, as illustrated in FIG. 1, the peripheral devices may include a hard disk 130, an inband network interface card (NIC) 132, and an out-of-band network interface card 134. Additionally, in other embodiments, the computing device 100 may include additional or other peripheral devices depending upon, for example, the intended use of the computing device. Further, it should be appreciated that the computing device 100 may include other components, sub-components, and devices not illustrated in FIG. 1 for clarity of the description. For example, it should be appreciated that the memory controller hub 118 may include a video controller for controlling a video display or interface and the input/output controller hub 120 may include an interrupt controller for generating interrupt events.

As illustrated in FIG. 1, at least one of the processor cores 108, 110, 112, 114 is sequestered by a platform resource layer 138 for handling management interrupts such as system management interrupts and/or platform management interrupts. In the illustrative embodiment, the processor core 114 is sequestered to handle the management interrupts and is allocated to the platform resource layer (PRL) 138. The remaining processor cores 108, 110, 112 are allocated to the main partition 136 and may perform other functions such as executing an operating system. It should be appreciated that because the processor core 114 has been allocated to the platform resource layer 138, the processor core 114 is “hidden” from any operating system being executed by the remaining processor cores 108, 110, 112. Although only a single processor core 114 has been sequestered for handling management interrupt events in the illustrative embodiment of FIG. 1, additional processor cores may be similarly sequestered in other embodiments. In addition, it should be appreciated that in other embodiments, the computing device 100 may be a multi-processor system. In such embodiments, the sequestered core or cores may be from the same or different processors. As such, the processors of such a multi-processor system may include a plurality of processor cores each of which are sequestered to the platform resource layer 138, allocated to the main partition 136, or a combination thereof.

It should also be appreciated that the platform resource layer 138 may include other devices and components of the computing device 110, each of which is “hidden” from any operating system being executed by the processor cores 108, 110, 112. In addition to handling management interrupt events such as system management interrupts and platform management interrupts, the platform resource layer 138 may perform other functions such as network communication acceleration, mathematical calculation acceleration, and other functions.

In use, when a management interrupt event, such as a system management interrupt and platform management interrupt, is generated by the chipset 104, the management interrupt is directed to the sequestered processor core 114. That is, unlike a typical computing device wherein the management interrupt is broadcasted to each processor core 108, 110, 112, 114, the management interrupt is directed only to the sequestered processor core(s) 114. In this way, the processor cores 108, 110, 112 may continue processing and performing other functions while the sequestered processor core 114 handles the generated management interrupt (e.g., the system management interrupt or the platform management interrupt). If the management interrupt requires the attention or processing of the remaining processor cores 108, 110, 112, the sequestered processor core 114 may be configured to broadcast the management interrupt (or a new management interrupt in response to the original management interrupt event) to the remaining processor cores 108, 110, 112.

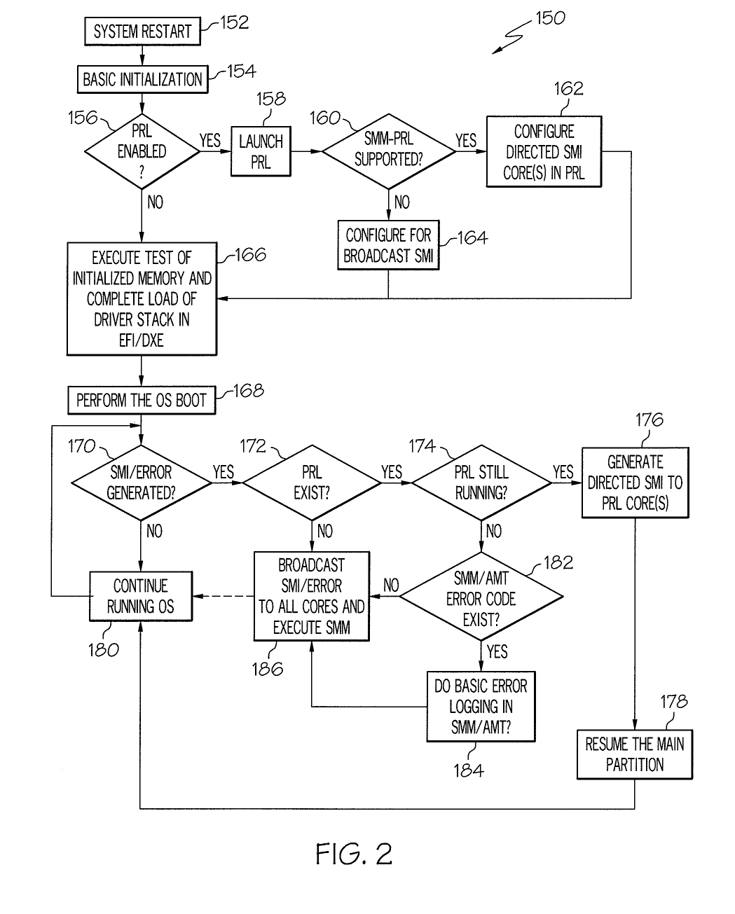

Referring now to FIG. 2, an algorithm 150 for handling management interrupts for use by the computing device 100 begins with block 152 in which the computing device 100 performs a system restart. In block 154, the computing device 100 performs some basic initialization including processor initialization procedures and memory cache initialization procedures. In block 156, the computing device 100 determines if the platform resource layer 138 is enabled. If so, the platform resource layer 138 is launched in block 158.

In block 160, the computing device 100 determines if the platform resource layer 138 supports the handling of management interrupts such as system management interrupts and/or platform management interrupts. If so, the computing device 100 is configured for directed management interrupt handling in block 162. That is, the chipset 104 is configured to direct any management interrupt such as a system management interrupt or a platform management interrupt to the sequestered processor core 114, rather than broadcasting the management interrupt to all processor cores of the processor 102. To do so, an identifier of the sequestered processor core 114 may be stored and used by the chipset 104 to direct the management interrupt to the appropriate processor core. For example, the identifier may be stored in a register of the chipset 104, in a memory location of the memory devices 122, 124, or in another memory location from which the chipset 104 may retrieve the identifier. Such functionality may be embodied in the Unified Extensible Firmware Interface (UEFI) of the computing device 100.

If the platform resource layer 138 does not support directed management interrupt handling, the computing device 100 is configured to handle such interrupt events by broadcasting the management interrupt to each processor core 108, 110, 112, 114 in block 164. For example, if the chipset 104 generates a system management interrupt (or a platform management interrupt in some embodiments), the chipset 104 is configured to broadcast the system management interrupt to each processor core 108, 110, 112, 114. In response, each processor core 108, 110, 112, 114 is configured to enter system management mode to handle the system management interrupt.

In block 166, the computing device 100 continues the initialization process. For example, the computing device 100 may initialize the main memory 122, 124 and complete the loading of the driver stack in the Extensible Firmware Interface (EFI) and/or Driver Execution Environment (DXE). The operating system is booted in block 168 and is executed by the remaining or un-sequestered processor cores 108, 110, 112 of the multi-core processor 102.

During the execution of the operating system by the processor cores 108, 110, 112, the computing device 100 determines if a management interrupt, such as a system management interrupt, a platform management interrupt, a bus error (BERR), a parity error (PERR), a system error (SERR), or other management interrupt/error, has been generated. If so, the computing device 100 determines if the platform resource layer 138 exists in block 172 and, if so, whether the platform resource layer 138 is currently running in block 174. If the platform resource layer 138 is still running, the system management interrupt (e.g., the system management interrupt or the platform management interrupt) is directed to the processor core 114 sequestered by the platform resource layer 138 and allocated to handling the management interrupt events. As discussed above, the chipset 104 may be configured to direct the system management interrupt or platform management interrupt to the sequestered processor core 114 via use of an identifier code or the like. In response to receiving the management interrupt, the sequestered processor core 114 is configured to enter system management mode to handle the management interrupt. For example, the processor core 114 may migrate a portion of the memory, update a memory page, or perform another function in response to and depending on the type of management interrupt event. If management interrupt requires the attention of the remaining processor cores 108, 110, 112, the sequestered processor core 114 may broadcast the management interrupt (or a secondary management interrupt in response to the original management interrupt) to the main partition processors 108, 110, 112.

If the processor core 114 broadcasts the management interrupt to the main partition processor cores 108, 110, 112, the execution of the main partition is resumed in block 178. Alternatively, if the allocated processor core 114 independently handles the management interrupt, the remaining processor cores 108, 110, 112 continue execution of the main partition in block 178. In block 180, the processor cores 108, 110, 112 continue execution of the operating system. In this way, the algorithm 150 loops between block 170 and block 180 until a management interrupt event is generated.

Referring back to block 174, if the platform resource layer 138 is not running at the time of the management interrupt event, the computing device 100 determines if the management interrupt includes or is defined by a system management mode error code and/or an active management technology (AMT) error code in block 182. If so, the management interrupt is logged in system management mode and/or in active management technology in block 184. If not or after basic error logging has been performed in block 184, the management interrupt is broadcasted to each of the processor cores 108, 110, 112, 114 in block 186. In response, each of the processor cores 108, 110, 112, 114 enters system management mode to handle the management interrupt. Depending on the particular interrupt event, the un-sequestered processor cores 108, 110, 112 may resume the execution of the operating system after the management interrupt event has been handled.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method comprising:
creating an operating system partition having one or more processor cores to execute an operating system of a computing device,
creating a platform resource layer partition having one or more processor cores to sequester the one or more processor cores of the platform resource layer from the one or more processors of the operating system partition, and
directing all management interrupts to the platform resource layer partition and not to the operating system partition for handling.

2. The method of claim 1, wherein the management interrupt is selected from a group of management interrupts comprising a system management interrupt and a platform management interrupt.

3. The method of claim 1, further comprising creating the partition resource layer before creating the operating system resource layer.

4. The method of claim 1, wherein creating the platform resource layer comprises selecting the one or more processor cores of the platform resource layer from a sub-set of processor cores that are designated as hot spare cores.

5. The method of claim 1, further comprising broadcasting the management interrupt from the platform resource layer partition to the operating system partition in response to the one or more processor cores of the platform resource layer partition handling the management interrupt.

6. The method of claim 1, further comprising handling the management interrupt with the one or more processor cores of the platform resource layer partition without disrupting operation of the one or more processor cores of the operating system partition.

7. The method of claim 1, further comprising
creating another operating system partition having one or more processor cores to execute an operating system of a computing device, and
handling the management interrupt with the one or more processor cores of the platform resource layer partition without disrupting operation of the one or more processor cores of the operating system partition and without disrupting operation of the one or more processors of the another operating system partition.

8. The method of claim 1, further comprising creating the platform resource layer in response to executing instructions of a firmware device during pre-boot phase of the computing device.

9. A machine readable medium comprising a plurality of instructions, that in response to being executed, result in a computing device
sequestering at least one processor core of a plurality of processor cores of the computing device from other processor cores of the computing device, and
configuring the computing device to deliver management interrupts to the at least one sequestered processor and to not deliver the management interrupts to the other processor cores of the computer device.

10. The machine readable medium of claim 9, wherein
management interrupts are system management interrupts, and
the plurality of instructions further result in the computing device, configuring the computing device to deliver system management interrupts to the at least one sequestered processor core and to not deliver the system management interrupts to the other processor cores of the computer device.

11. The machine readable medium of claim 10, wherein
management interrupts are platform management interrupts, and
the plurality of instructions further result in the computing device, configuring the computing device to deliver platform management interrupts to the at least one sequestered processor core and to not deliver the platform management interrupts to the other processor cores of the computer device.

12. The machine readable medium of claim 9, wherein the plurality of instructions further result in the computing device sequestering the at least one processor core from the plurality of processor cores by
creating a platform resource layer partition and allocating the at least one processor core to the platform resource layer, and
creating an operating system partition and allocating the other processor cores to the operating system partition.

13. The machine readable medium of claim 9, wherein the plurality of instructions further result in the computing device sequestering the at least one processor core from the plurality of processor cores by
creating a platform resource layer partition and allocating the at least one processor core to the platform resource layer, and
creating an operating system partition and allocating the other processor cores to the operating system partition after creating the platform resource layer.

14. The machine readable medium of claim 9, wherein the plurality of instructions further result in the computing device selecting the at least one processor core of the platform resource layer from a sub-set of processor cores that are designated as hot spare cores.

15. The machine readable medium of claim 9, wherein the plurality of instructions further result in the computing device sequestering the at least one processor core during pre-boot phase of the computing device.

16. A system comprising:
a processor; and
a memory device coupled to the processor, the memory device having stored therein a plurality of instructions, which when executed by the processor cause the processor to
create an operating system partition having one or more processor cores to execute an operating system of a computing device,
create a platform resource layer partition having one or more processor cores to sequester the one or more processor cores of the platform resource layer from the one or more processors of the operating system partition, and
direct all system management interrupts and platform management interrupts to the platform resource layer partition and not to the operating system partition for handling.

17. The system of claim 16, wherein plurality of instructions cause the processor to create the partition resource layer before creating the operating system resource layer.

18. The system of claim 16, wherein to create the platform resource layer comprises to select the one or more processor cores of the platform resource layer from a sub-set of processor cores that are designated as hot spare cores.

19. The system of claim 16, wherein the plurality of instructions further cause the processor to broadcast the system management interrupts and the platform management interrupts from the platform resource layer partition to the operating system partition in response to the one or more processor cores of the platform resource layer partition handling the system management interrupts and the platform management interrupts.

20. The system of claim 16, wherein the plurality of instructions further cause the processor to handle the system management interrupts and the platform management interrupts with the one or more processor cores of the platform resource layer partition without disrupting operation of the one or more processor cores of the operating system partition.
